(19) United States
(12) Patent Application Publication
(10) Pub. No.: US 2011/0307213 A1
(43) Pub. Date: Dec. 15, 2011

(54) SYSTEM AND METHOD OF SENSING ATTITUDE AND ANGULAR RATE USING A MAGNETIC FIELD SENSOR AND ACCELEROMETER FOR PORTABLE ELECTRONIC DEVICES

(76) Inventors: Yang Zhao, Andover, MA (US); Dong An, Cupertino, CA (US)

(21) Appl. No.: 13/193,139

(22) Filed: Jul. 28, 2011

Related U.S. Application Data
(63) Continuation-in-part of application No. 11/825,993, filed on Jul. 10, 2007.
(60) Provisional application No. 60/819,735, filed on Jul. 10, 2006.
(60) Provisional application No. 60/906,100, filed on Mar. 9, 2007.

(51) Int. Cl. G06F 15/00; G01P 15/105

(52) U.S. Cl. 702/153; 73/514.31

(57) ABSTRACT

A system for determining motion information including attitude and angular rate of a dynamic object. The system includes a magnetic-field sensing device to measure in the body coordinate frame of reference an intensity and/or direction of a magnetic field in three substantially orthogonal directions; an acceleration-sensing device adapted to measure total acceleration of the object in the body coordinate frame of reference; and a processor adapted to calculate attitude and angular rate by combining total acceleration measurement data and magnetic field measurement data with the kinematic model in a filter.

### CROSS REFERENCE TO RELATED APPLICATIONS

The present application is a continuation-in-part of U.S. patent application Ser. No. 11/825,993 filed on Jul. 10, 2007, entitled “SYSTEM FOR SENSING YAW RATE USING A MAGNETIC FIELD SENSOR AND PORTABLE ELECTRONIC DEVICES USING THE SAME,” which claims the benefit of Provisional Patent Application No. 60/906,100 dated Mar. 9, 2007, entitled “Motion and Attitude Sensing for Portable Electronic Devices” and Provisional Patent Application No. 60/819,735 dated Jul. 10, 2006, entitled “Yaw Rate Sensing by Using Magnetic Field Sensor (Compass)—Replacing Gyro Function with a Compass”.

### STATEMENT REGARDING FEDERALLY SPONSORED RESEARCH OR DEVELOPMENT

N/A

### FIELD OF THE INVENTION

The present invention relates to input technology for electronic devices and, more particularly, to an electronic device or apparatus that is adapted to produce angular rate and dynamic attitude angles using a three-axis magnetometer and three-axis accelerometer for generating input signals corresponding to its attitude or change in attitude or angular rates to an application program being executed on the electronic device itself.

### BACKGROUND OF THE INVENTION

Portable devices and especially, although not exclusively, portable wireless devices, e.g., mobile telephones, cellular telephones, cordless telephones, text messaging devices, pagers, talk radios, portable navigation systems, portable music players, portable video players, portable multimedia devices, personal digital assistants (PDAs), portable games, and the like, are being used increasingly in everyday life. As technology advancements are made, portable electronic devices are integrating more and more applications while shrinking in size and weight. Typically, the user interface and the power source comprise most of the volume and weight of the portable device.

The user interface of a portable device and, more particularly, the signal input portion of the user interface, is very important to the operation and operability of the portable device. Conventionally, user command input and data input into portable devices have been performed using input devices such as a keyboard or keypad, a mouse, a joy-stick, a stylus or digital pen or a gesture using the device itself. For scrolling and menu navigation, arrow buttons, thumbwheels, game-handles, and other devices may also be included with the portable devices.

However, as portable devices become more sophisticated and smaller, traditional keypad, arrow button, thumbwheel, or digital pen/stylus entry may be inconvenient, impractical or non-enjoyable if the component parts are too small. More complex menus, three-dimensional maps, and advanced games requiring more sophisticated navigation exacerbate the problem.

The development of motion sensing devices, e.g., accelerometers, gyroscopes, and the like, and their integration into a portable device have been suggested by others to generate input signal data with respect to motion for the applications embedded in the portable device. Accelerometers measure specific force acceleration, i.e., “total” acceleration, which includes gravitational acceleration. Typically, a three-axis accelerometer measures three orthogonal components of the total acceleration vector. Magnetometers are exemplary magnetic-field sensing devices that measure the intensity and/or direction of a local magnetic field. Three-axis magnetometers sense the intensity and/or direction of an incident magnetic field by measuring local x-axis, y-axis, and z-axis components of the magnetic field vector.

A magnetic compass is a device capable of providing a direction angle with respect to the Earth's magnetic north pole. A simple magnetic compass could be a simple magnetic-field sensing device that, when disposed on a level plane, provides a direction angle, i.e., “heading”, to the Earth's magnetic north pole. A rate gyroscope is a particular device that measures angular rate applied to a sensitivity axis.

Recently, MEMS (microelectromechanical systems) accelerometers and magnetometers have been widely combined to form an “e-compass”, or “digital compass”, or “orientation sensor”. Acceleration data are used to compute roll and pitch angles. Further, computed roll and pitch angles are used to transform the Earth's magnetic field measurement data taken by a magnetometer, which are measured in the carrier's body frame of reference, into magnetic field measurement data in a local-level frame of reference. The magnetic-field measurement data in a local-level frame of reference are used to compute yaw, i.e., heading angle.

For example, U.S. Pat. No. 7,138,979 to Robin, et al. discloses methods and systems for generating input signals based on the orientation of the portable device. Robin discloses using cameras, gyroscopes, and/or accelerometers, to detect a change in the spatial orientation of the device and, further, to generate position signals that are indicative of that change. According to Robin, the input signal can be used to move a cursor, to operate a game element, and so forth.

U.S. Patent Application Publication Number 2006/0046848 to Abe, et al. discloses a game suitable for play on a portable device that includes a vibration gyroscope sensor. The vibration gyroscope sensor detects an angular velocity from a change in vibration resulting from Coriolis forces acting in response to the change in orientation. According to the teachings of Abe, the gyroscope sensor detects an angular velocity of rotation about an axis perpendicular to the display screen of the game. From angular velocity data, two-dimensional angle of rotation data are calculated.

Gyroscope sensors disclosed by Robin and Abe, however, are expensive and relatively large in dimension and weight. Robin and Abe also address the two-dimensional “orientation” of a portable device rather than the three-dimensional “attitude” of the portable device. Therefore, it would be desirable to provide methods, devices, and systems for generating input signal data about the three-dimensional attitude of a portable device. It would also be desirable to provide devices and systems for generating input signal data that are more economical, relatively smaller, and relatively lighter than conventional devices with gyroscope sensors.

Gyroscopes, traditionally, have been an essential component of inertial attitude sensing systems, to provide angular rate and dynamic angles. However, including three-axis gyroscopes could significantly increase cost, power consumption, and size, which is not desirable in battery-powered, portable devices. In addition, current low-end MEMS gyroscopes themselves are subject to many performance issues, e.g., bias drift, and are not yet at the same level of maturity as magnetometers and accelerometers for portable consumer electronic systems. According to the present invention, angular rate and dynamic angles can be detected using an electronic compass, as will be described below.

Advantageously, in contrast with gyroscopes, an electronic compass can sense yaw, pitch, and roll angular rate as well as inertial attitude position. Gyroscopes do not provide absolute angular position information, but, rather, only provide a relative change of angular position information.

Gyroscopes also tend to be relatively large in comparison with magnetometers. For example, a three-axis magnetometer can be manufactured to be as small or smaller than about 0.2 in.×0.2 in.×0.04 in. (about 5 mm×5 mm×1.2 mm). Three-axis gyroscopes will be significantly larger.

Conventional attitude-sensing includes a two- or a three-axis accelerometer, a three-axis magnetometer, and a three-axis gyro to provide full motion status, i.e., pitch, roll, and yaw. Although accelerometers are becoming less and less expensive, gyroscopes remain several times more expensive than accelerometers due to their technological and manufacturing complexity.

Additionally, in ideal free space, which is to say, under conditions having zero gravity and no magnetic field, six-degree of freedom motion information can be gathered using a two- or three-axis accelerometer and a three-axis gyroscope. However, on Earth, existing known gravitational acceleration and magnetic field can serve as useful references so that at motion information can be determined using different ways than in free space. As a result, a magnetic field sensing device to replace the gyroscope at much lower cost is desirable.

An “ecompass”, i.e., electronic compass, digital compass, or orientation sensor, combines an accelerometer and a magnetometer in a common carrier body to provide, inter alia, magnetic-heading angle data. However, there are two major disadvantages of using an ecompass for motion-based applications executable on the carrier. First, angular rates are not measured directly. Second, tilt angle (roll and pitch) measurements are only accurate when the carrier is static and, hence, do not account for dynamic effects. The inability to account for these dynamic effects produces magnetic heading inaccuracies.

U.S. Patent Application Publication Number 2003/0158699 to Townsend, et al. (“Townsend”) discloses an orientation system that combines accelerometer and magnetometer measurement data to compute static roll, static pitch, and static yaw angles. Townsend, however, does not teach determining dynamic roll, dynamic pitch or dynamic yaw angles or angular rates. Hence, Townsend's system suffers from both of the disadvantages of common ecompasses.

U.S. Pat. No. 7,216,055 to Horton, et al. (“Horton”) describes an Attitude and Heading Reference System (AHRS) that includes a three-axis gyroscope, a three-axis accelerometer, and a magnetic-field sensing device. Disadvantageously, the gyroscope significantly increases cost, size, and power requirements. In Horton, gyro data are integrated to obtain a roll, pitch, and yaw angle solution. Furthermore, Horton includes a Kalman filter to estimate roll, pitch, and yaw angle error, which is used to offset attitude drift that is drifting over time, as well as gyro bias.

Kalman filtering is well-known to those of ordinary skill in the art and is used in a variety of applications. However, Kalman filtering provides a standard computation framework having state and measurement vector formulations. Consequently, state and measurement equations must be specified for each discrete application.

In consumer applications, when cost is the ultimate important factor, a lower cost solution to fulfill a functional need will be key to successful commercialization. Therefore, it would be desirable to provide an attitude- and motion-sensing device for measuring magnetic field strength and acceleration about or in three orthogonal axes for an object, as well as determining the attitude and angular rate of the object.

### BRIEF SUMMARY OF THE INVENTION

An attitude- and motion-sensing system for a portable electronic device, such as a cellular telephone, a game device, and the like, is disclosed. The system, which can be integrated into the portable electronic device, includes a two- or three-axis accelerometer and a three-axis magnetic field sensor, such as an electronic compass. The measurements from the accelerometer and magnetic field sensor are first processed by a signal processing unit that calculates attitude angles and angular rate. These data are then translated into input signals for a specific application program associated with the portable electronic device.

More specifically, the system is capable of directly measuring dynamic pitch/roll/yaw angles and dynamic pitch/roll/yaw angular rates without using a gyroscope by using in a filter attitude kinematic properties in combination with measurement data from the accelerometer and magnetometer.

### BRIEF DESCRIPTION OF THE DRAWINGS

The foregoing and other objects, features, and advantages of the invention will be apparent from the following more particular description of preferred embodiments of the invention, as illustrated in the accompanying drawings in which like reference characters refer to the same parts throughout the different views.

FIG. 1 is a diagram illustrating the attitude angles of a rigid object in space in accordance with the prior art;

FIG. 2 is a block diagram illustrating a procedure of input signal generation in accordance with the prior art;

FIG. 3 is a diagram of an apparatus using the present technology in connection with a three-dimensional map application;

FIG. 4 is a diagram of an apparatus using the present technology in connection with a flight simulator gaming application;

FIG. 5 is a flow chart of a method of providing attitude and change of attitude signals to an application program in accordance with the present invention;

FIG. 6A is a diagram illustrating a pitch angle with respect to a carrier body frame of reference and a local navigation tangent frame of reference in accordance with the prior art;

FIG. 6B is a diagram illustrating a roll angle with respect to a carrier body frame of reference and a local navigation tangent frame of reference in accordance with the prior art;

FIG. 6C is a diagram illustrating a yaw angle with respect to a carrier body frame of reference and a local navigation tangent frame of reference in accordance with the prior art;

FIG. 7 is a diagram of attitude and motion-sensing systems in accordance with the present invention;

FIG. 8 is a diagram of a first attitude and angular rate filter in accordance with the present invention; and

FIG. 9 is a diagram of a second attitude and angular rate filter in accordance with the present invention.

### DETAILED DESCRIPTION

The present invention relates to an attitude sensing device for sensing the attitude of an object and a motion sensing device for sensing angular rate of an object such as a carrier. The attitude and motion sensing device includes a three axis magnetic field sensor such as a three-axis magnetometer, and a two- or three-axis accelerating-sensing device, such as a two- or three-axis accelerometer. More particularly, the attitude and motion sensing device, which is integrated into the carrier, uses an electronic compass, to determine the attitude and angular rates of the carrier for generating input signals corresponding to attitude and angular rate for other applications in the carrier, such as three-dimensional (3-D) maps, games, and so forth.

### Reference Frame

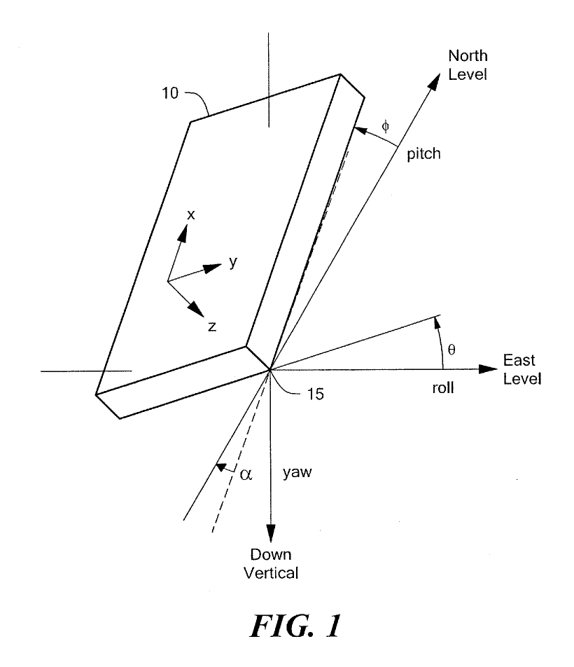

The attitude of a rigid object 10 in space can be described by three angles: yaw, pitch, and roll (see FIG. 1). Typically, these angles are referenced to a local tangent plane, for example, a plane perpendicular to the Earth's gravitational vector or the ecliptic plane of the Earth. Yaw (Ψ) is defined as an angle measured clockwise in the local tangent plane from a true North direction, i.e., the Earth's magnetic polar axis, to the forward direction of the object 10. Pitch (θ) is defined as an angle between the object's longitudinal axis and the local horizontal plane. By convention, in aerospace applications, positive pitch refers to “nose up” and negative pitch refers to “nose down”. Roll (φ) is defined as a rotation angle about the longitudinal axis between the local horizontal plane and the actual plane of the object. By convention, in aerospace applications, positive roll refers to “right wing down” and negative roll refers to “right wing up”.

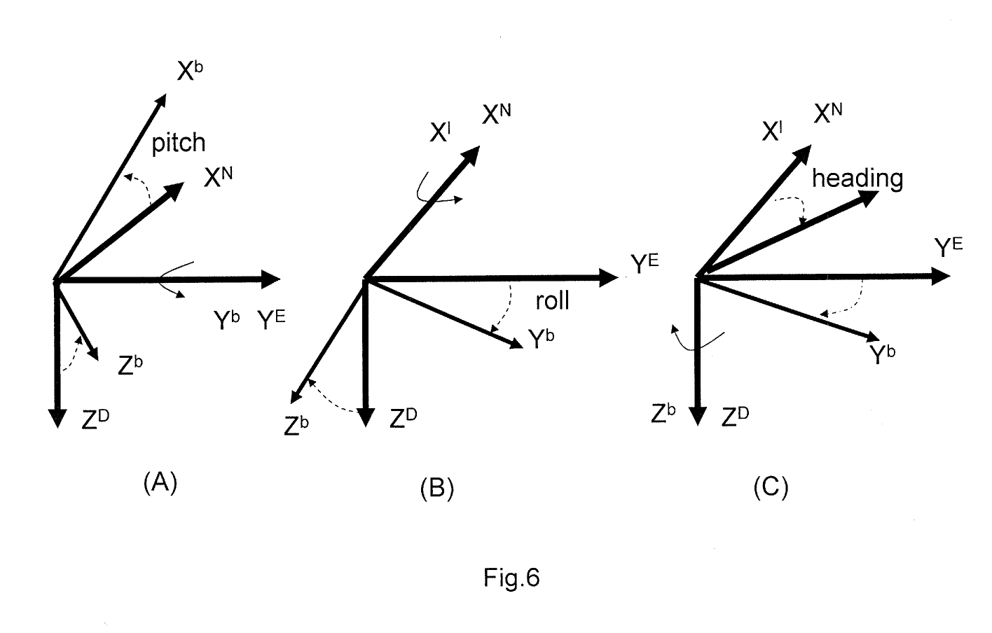

FIGS. 6A-6C show the relationship between a local navigation tangent frame of reference (T), a standard body (“object” or “carrier”) coordinate frame of reference (B), and a local-level frame of reference (L), all three of which can be used to describe the object's attitude. The local navigation tangent frame of reference (T) is defined as North (N), East (E), and Down (D) axes. Hence the axes in the local navigation tangent frame of reference (T) are labeled X^{N}, Y^{E}, and Z^{D}. The axes of the body coordinate frame of reference (B) are defined as a positive X^{B} axis through the object's forward direction, a positive Y^{B} axis through the “right” direction, and a positive Z^{B} axis directed “down”.

Optionally, the three axes of the acceleration-sensing device and of the magnetic-field sensing device can be aligned with the body coordinate frame of reference (B). However, any offset or misalignment will not affect the results or teachings of the present invention. The x-axis (X^{L}) of the local-level frame of reference (L) is defined as the projection of the x-axis of the body frame of reference (X^{B}) in the local-level plane. The y-axis (Y^{L}) of the local-level frame of reference (L) is perpendicular to the x-axis (X^{L}) of the local-level frame of reference (L). The z-axis (Z^{L}) of the local-level frame of reference (L) is down.

### Input Signal Generation System

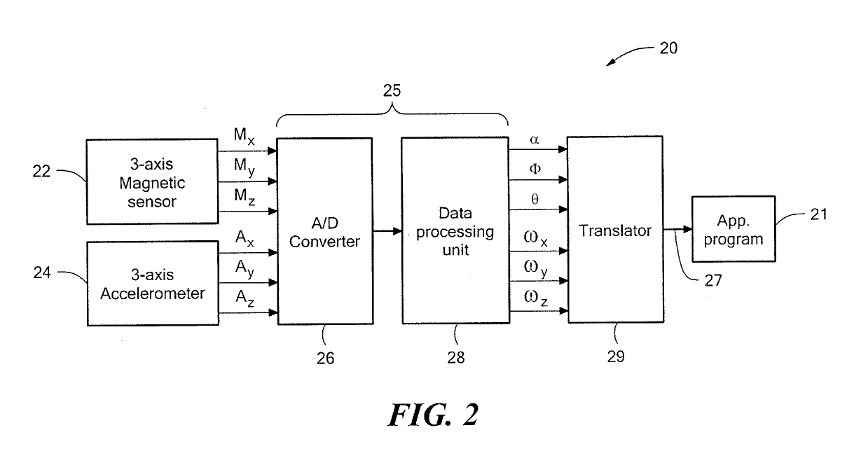

FIG. 2 shows a block diagram of a typical input signal generation system 20. The three-axis magnetic sensor 22, three-axis accelerometer 24, A/D converter 26, and data processing unit 28 are structured and arranged to provide an attitude and angular rate solution. The translator 29 uses the attitude and angular rate solution to generate an appropriate input signal 27 to application program 21.

When the attitude of a sensing device(s) 22, 24 changes, which is to say that, the sensing device(s) 22, 24 rotates about at least one of its X-, Y-, and Z-axes, the sensing device(s) 22, 24 generates an output signal that is proportional to the measured magnetic field strengths Mₓ, M_{y}, and M_{z} and to the accelerations Aₓ, A_{y}, and A_{z}. Typically, a magnetic field sensor 22 senses Mₓ, M_{y}, Mₓ and an accelerometer 24 senses Aₓ, A_{y}, A_{z}.

The six magnetic field strength and acceleration parameters are transmitted to a processing unit 25, which can be integrated into one or more of the sensing devices 22, 24 or which can be a separate, local or remote electronic device. The processing unit 25 includes signal and data processing units to process the measured parameter data. For example, the processing unit 25 can include an analog-to-digital (A/D) converter 26 for A/D conversion, a data processing unit 28 for processing data, and the like.

More specifically, the data processing unit 28 can be adapted to process the magnetic field and acceleration measurements to calculate attitude angles and angular rates. These data can then be input into a translator unit 29 that is adapted to translate the data into an input signal 27. The translated input signal 27 is then transmitted to an electronic processing device 21 that includes an application or driver program for manipulating the translated attitude angle and angular rate data into motion status.

According to the prior art, three-axis magnetic field sensors can be adapted to measure the magnetic field strength about an X-, a Y-, and a Z-axis, respectively, Mₓ, M_{y}, Mₓ, while three-axis accelerometers can be adapted to measure acceleration in the X-, Y-, and Z-axis, respectively, Aₓ, A_{y}, A_{z}. Thus, the pitch of the object 10 in space is calculated by the formula:

Pitch=θ=−arcsin(accelₓ^{B}) (1)

and the roll of the object 10 in space is calculated by the formula:

roll=φθ=arctan 2(accel_{y}^{B},accel_{z}^{B}) (2)

in which [accelₓ^{B}, accel_{y}^{B}, accel_{z}^{B}]^{T} correspond to acceleration measurements (in g) from the three-axis accelerometer taken in the carrier body frame of reference. Accordingly, one can determine both pitch and roll using a two- or three-axis accelerometer. It should be noted that the roll in equation (2) can also be computed approximately using the equation roll=θ=arcsin(accel_{y}^{B}), when a two-axis accelerometer is used and the carrier's pitch angle is relatively small, i.e., less than 20 degrees.

Calculation of yaw is slightly more involved and requires measurement data from both the accelerometer and the magnetic field sensor. More particularly, yaw can be calculated using the following equations:

$$\begin{matrix}[ \begin{matrix}{mag}_{x}^{L} \\ {mag}_{y}^{L}\end{matrix} ] = \\ [ \begin{matrix}cos ( θ ) * {mag}_{x}^{B} + sin ( θ ) * sin ( φ ) * {mag}_{y}^{B} + cos ( φ ) * {mag}_{z}^{B} \\ sin ( φ ) * {mag}_{z}^{B} - cos ( φ ) * {mag}_{y}^{B}\end{matrix} ] and & ( 3 ) \\ heading = ψ = atan 2 ( {mag}_{y}^{L} , {mag}_{x}^{L} ) , & ( 4 )\end{matrix}$$

in which [magₓ^{B}, mag_{y}^{B}, mag_{z}^{B}]^{T} correspond to the Earth's magnetic field from the three-axis magnetometer as measured in the carrier body frame of reference (B). Approximate angular rates can be obtained by calculating the time derivative of the angle change using, respectively, the following equations:

$${ω}_{x} = \frac{d φ}{d t} ; {ω}_{y} = \frac{d θ}{d t} ; {ω}_{z} = \frac{d Ψ}{d t} \qquad ( 5 )$$

in which ωₓ, ω_{y}, ω_{z} correspond to the angular rates of the object's rotation about the X-, Y-, and Z-axis, respectively.

This approach has the superior advantage of a small computation load. Notwithstanding, disadvantages include time latency, dynamic errors, ignoring the coupling of roll/pitch/yaw, and being vulnerable to changing hard/soft iron environment, which could be unacceptable in some applications. This approach assumes that the body-axis rotational angular rates are equal to the rate of change in Euler attitude angles, which is approximately accurate. Those skilled in the art can appreciate that, with mobile devices, hard and soft iron distortions caused by local concentrations of hard/soft magnetic materials, e.g., iron, can cause the angles to change continuously.

The present invention provides highly-accurate angular rate and attitude measurements in harsh environments that could encompass highly-dynamic maneuvers and vibration.

### Enhanced Attitude and Angular Rates

A major improvement to the state-of-the-art includes the integration of an attitude and angular rate filter into the system to attain precise and immediate attitude and angular rate. As will be described in greater detail below, two preferred embodiments of the attitude and angular rate filter using an attitude kinematic model as part of the filter state equation (designated first and second attitude and angular rate filters) are disclosed.

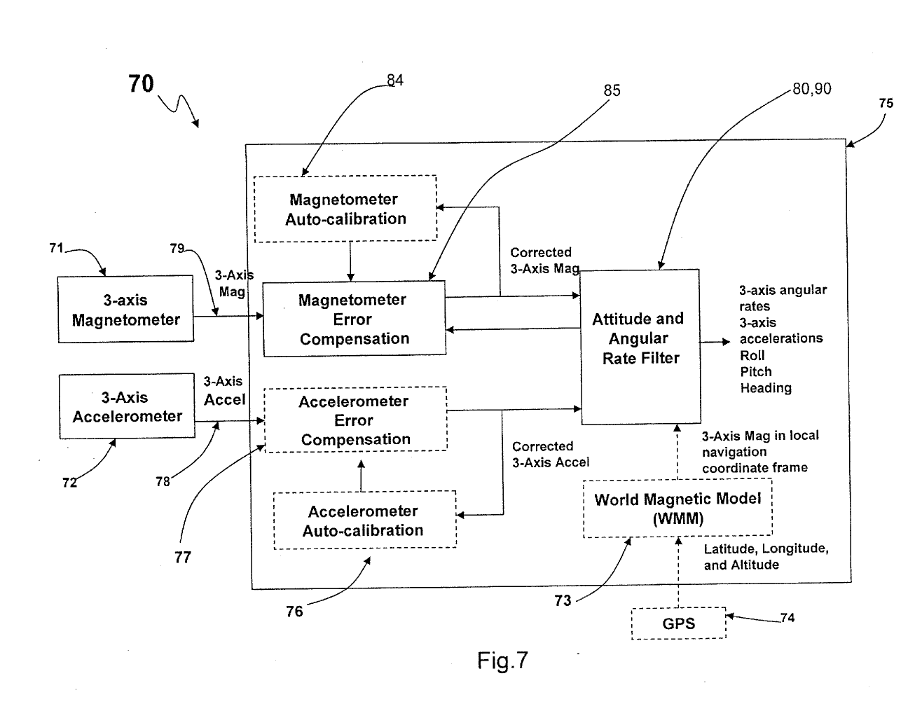

Referring to FIG. 7, a system 70 adapted to determine three-axis angular rate data, dynamic roll, dynamic pitch, and dynamic heading angle measurement data for providing attitude- and motion related input data into a program or application is shown as another preferred embodiment of devices 22, 24, 26, and 28 (FIG. 2). The system 70 includes a three-axis magnetometer 71 that is adapted to measure dynamically the Earth's magnetic field and to generate magnetic field measurement data signals 79 that are expressed in the carrier's body coordinate frame of reference (B); a three-axis accelerometer 72 that is adapted to generate total acceleration measurement data signals 78 that are also expressed in the carrier's body coordinate frame of reference (B); and a processor 75, which receives the data signals 78 and 79 to compute three-axis angular rate, three-axis acceleration, and attitude angles.

The magnetometer 71 and accelerometer 72 have been described in detail hereinabove and will not be discussed further in great detail except as necessary to explain their relationship to and interaction with each other and to/with the processor 75. The processor 75 is adapted, inter alia, to receive and store the data from the magnetometer 71 and accelerometer 72 and, moreover, to use said data to calculate and to output three-axis angular rate data and dynamic roll/pitch/heading angle data for input into an application or program running on the object or carrier. Preferably, the processor 75 optimally combines the Earth's magnetic field measurement data 79 and total acceleration measurement data 78 with kinematic models of the carrier's attitude and angular rate using one of the attitude and angular rate filter(s) 80, 90.

The Earth's magnetic field measurements are subject to local magnetic field distortions such as soft iron and hard iron distortions. In small mobile device applications, hard and soft iron distortions from the host system may keep changing. As a result, the processing device 75 includes a magnetometer auto-calibration module 84 (FIG. 7) and a compensation module 85 (FIG. 7). The magnetometer auto-calibration module 84 estimates magnetometer errors including the changing hard and soft iron distortion effects in demanding environments, based on the principle that the scalar length of the local magnetic field is a constant. The compensation module 85 uses the estimated magnetometer errors including the hard and soft irons to correct the raw magnetic field measurement data.

Also in small mobile device applications, low-cost accelerometers often are not well calibrated at the factory. As a result, accelerometers may have significant bias drift over operational time and temperature ranges. To further improve the accuracy of the accelerometer, the processing device 75 includes an accelerometer auto-calibration module 76 (FIG. 7) and a compensation module 77 (FIG. 7). The accelerometer auto-calibration module 76 estimates accelerometer error source, by taking advantage of the fact that accelerometers' raw outputs only reflect gravitational acceleration when the carrier is static. The compensation module 77 uses the estimated accelerometer error to correct the raw, total acceleration measurement data.

Magnetometer auto-calibration module 84 and accelerometer auto-calibration module 76 leverage the locus constraints of Earth's magnetic field vector measurements and Earth's gravitational acceleration measurements over time in a restricted geographic area. If there are no errors in the measurements, the locus should be a sphere. However, with sensor errors, including hard/soft errors, the locus becomes a ellipsoid. The sensor error estimation can be achieved by parameter identification of the ellipsoid that given locus constraints. The magnetometer auto-calibration module 84 and the accelerometer auto-calibration module 76 are implemented with the aims of enhancing the performance in a wide variety of operating environments, assuring compatibility, flexibility, and adaptability of the system 70 with the host systems and supporting new hardware capabilities.

As a preferred embodiment, a Kalman filtering-based framework approach is employed for the attitude and angular rate filter to simultaneously estimate roll/pitch/heading angles and angular rates from the Earth's magnetic field measurements and acceleration (specific force) measurements. A Kalman filter is a recursive optimal estimator for finding parameters of interest from indirect measurements that are observed over time that contain noise and other inaccuracies, not just for filtering out the noise from the data measurements. New measurements can be processed once they are available. The estimated parameters of interest are formed into a state vector. Indirect and noisy observations are formed into a measurement vector.

A state equation and a measurement equation need to be established for a Kalman filter. The computation of Kalman filtering includes two phases: time propagation and measurement updates. The time propagation propagates the state vector from the previous measurement time point to the current measurement time point as a prior estimate of the state vector at the current measurement time. The measurement update corrects the prior estimate of the state vector using the current measurement vector.

Mathematically, the attitude of a carrier can be expressed with an attitude quaternion. Following Euler's theorem, the components of the attitude quaternion are expressed as follows:

$$Q = [ \begin{matrix}{q}_{0} \\ {q}_{1} \\ {q}_{2} \\ {q}_{3}\end{matrix} ] \qquad ( 6 )$$

The carrier body frame-to-local navigation frame cosine rotation matrix is directly formed using the attitude quaternion as:

$${C}_{B}^{T} = [ \begin{matrix}{q}_{0}^{2} + {q}_{1}^{2} - {q}_{2}^{2} - {q}_{3}^{2} & 2 ( {q}_{1} {q}_{2} - {q}_{0} {q}_{3} ) & 2 ( {q}_{1} {q}_{3} + {q}_{0} {q}_{2} ) \\ 2 ( {q}_{1} {q}_{2} + {q}_{0} {q}_{3} ) & {q}_{0}^{2} - {q}_{1}^{2} + {q}_{2}^{2} - {q}_{3}^{2} & 2 ( {q}_{2} {q}_{3} - {q}_{0} {q}_{1} ) \\ 2 ( {q}_{1} {q}_{3} - {q}_{0} {q}_{2} ) & 2 ( {q}_{2} {q}_{3} + {q}_{0} {q}_{1} ) & {q}_{0}^{2} - {q}_{1}^{2} - {q}_{2}^{2} + {q}_{3}^{2}\end{matrix} ] \qquad ( 7 )$$

Dynamic roll, dynamic pitch, and dynamic yaw angles can be abstracted from the cosine rotation matrix, C_{B}^{T} as follows:

$$φ = roll = atan ( \frac{{C}_{B}^{T} ( 3 , 2 )}{{C}_{B}^{T} ( 3 , 3 )} ) \\ θ = pitch = - asin ( {C}_{B}^{T} ( 3 , 1 ) ) \\ ψ = yaw = atan ( \frac{{C}_{B}^{T} ( 2 , 1 )}{{C}_{B}^{T} ( 1 , 1 )} ) \qquad ( 8 )$$

One can define an attitude quaternion kinematic differential equation as:

$$[ \dot{Q} ] = [ \frac{1}{2} * {Ω}_{angularRate} * Q ] , \qquad ( 9 )$$

hence, the attitude quaternion differential equation includes a matrix representation of the angular Ω_{angularRate} (4×4 skew symmetric matrix). The angular rate matrix Ω_{angularRate} is made up of the angular rates about each coordinate axis as follows:

$${Ω}_{angularRate} = [ \begin{matrix}0 & - {ω}_{x} & - {ω}_{y} & - {ω}_{z} \\ {ω}_{x} & 0 & {ω}_{z} & - {ω}_{y} \\ {ω}_{y} & - {ω}_{z} & 0 & {ω}_{x} \\ {ω}_{z} & {ω}_{y} & - {ω}_{x} & 0\end{matrix} ] where \\ \overline{ϖ} = [ \begin{matrix}{ω}_{x} \\ {ω}_{y} \\ {ω}_{z}\end{matrix} ] \qquad ( 10 )$$

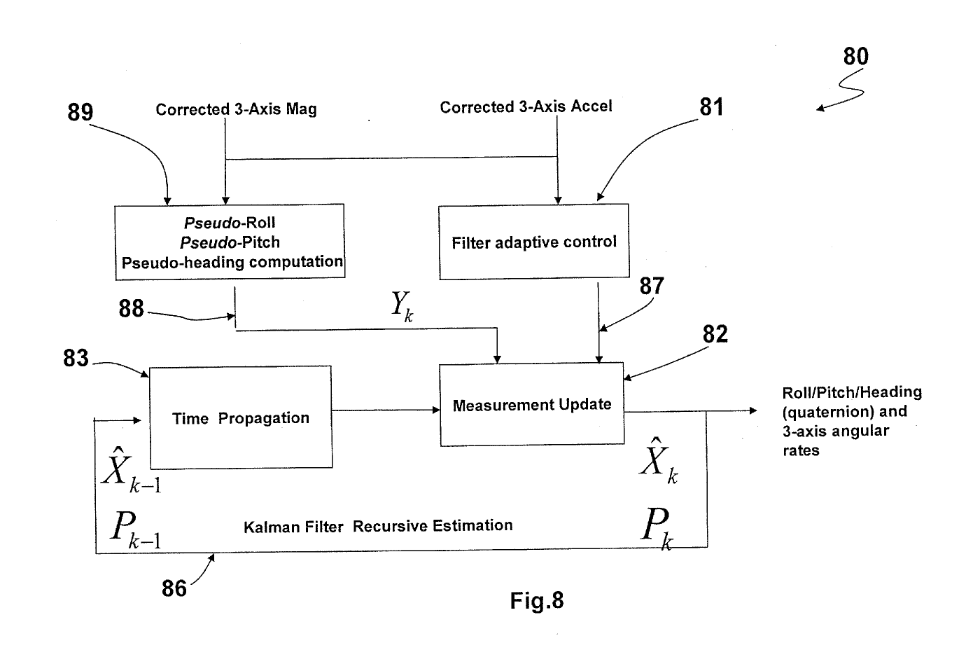

Referring to FIG. 8, a first attitude and angular rate filter 80 employs a state equation that is made up of the attitude quaternion differential equation and the angular rate kinematics differential model. The angular rate kinematics differential model can be modeled with low- and/or high-order processes. In a preferred embodiment, \dot{ω}ₓ, \dot{ω}_{y}, \dot{ω}_{z} can be modeled as first-order Markov processes.

The state equation is given by:

\dot{X}=f(X); (11)

and the state vector for the first attitude and angular rate filter 80 is represented by the equation:

X=[q₀,q₁,q₂,q₃,ωₓ,ω_{y},ω_{z}]^{T}. (12)

Roll/pitch/yaw that are directly computed by accelerometer data and magnetometer data are designated as pseudo-angles which are employed as the measurement vector of the first attitude and angular rate filter 80. The measurement equations of the first attitude and angular rate filter 80 uses Equation (8) which expresses the relationship of the attitude quaternion and roll/pitch/yaw. The pseudo-angle measurements are computed as follows:

$$\begin{matrix} pseudo\_roll = φ = arctan 2 ( {accel}_{y}^{B} , {accel}_{z}^{B} ) & ( 13 ) \\ pseudo\_Pitch = θ = - arcsin ( {accel}_{x}^{B} ) & ( 14 ) \\ [ \begin{matrix}{mag}_{x}^{L} \\ {mag}_{y}^{L}\end{matrix} ] = [ \begin{matrix}cos ( θ ) * {mag}_{x}^{B} + sin ( θ ) * sin ( φ ) * {mag}_{y}^{B} + cos ( φ ) * {mag}_{z}^{B} \\ sin ( φ ) * {mag}_{z}^{B} - cos ( φ ) * {mag}_{y}^{B}\end{matrix} ] & ( 15 ) \\ pseudo\_heading = ψ = atan 2 ( {mag}_{y}^{L} , {mag}_{x}^{L} ) & ( 16 )\end{matrix}$$

in which [magₓ^{B}, magₓ^{B}, magₓ^{B}]^{T} correspond to the Earth's magnetic field from the three-axis magnetometer as measured in the carrier body frame of reference (B); and [accelₓ^{B}, accel_{y}^{B}, accel_{z}^{B}]^{T} correspond to acceleration measurements (in g) from the three-axis accelerometer taken in the carrier body frame of reference.

A pseudo-roll, pseudo-pitch, and pseudo-heading computation module 89 performs the filter 80 measurement generation from which a measurement vector (pseudo-roll, pseudo-pitch, and pseudo-heading) are computed. The module 89 can be a stand-alone device or part of the processing device 75. A measurement update module 82 performs measurement update of the state vector for producing the computation output (Yₖ) 88 when a measurement vector is available. The updated state vector (Xₖ) 86 is, in turn, fed back recursively to a time propagation module 83. The time propagation module 83 performs the time propagation of the state vector between filter measurements.

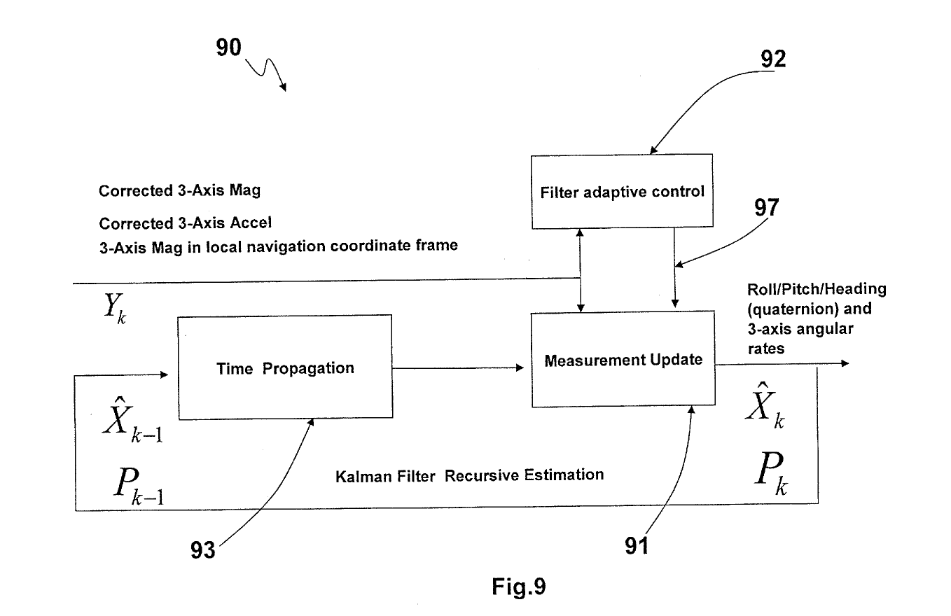

Referring to FIG. 9, a second attitude and angular rate filter 90 employs a state equation that is made up of the attitude quaternion differential equation, the angular rate kinematics differential model, and magnetometer errors. The state vector of the second attitude and angular rate filter 90 is represented by the equation:

X=[q₀,q₁,q₂,q₃,ωₓ,ω_{y},ω_{z},magₓ₋ₑᵣᵣₒᵣ,mag_{y-error},mag_{z-error}]^{T} (17)

in which magₓ₋ₑᵣᵣₒᵣ, mag_{y-error}, mag_{z-error} are magnetometer errors, which, in a preferred embodiment, can be modeled as constants. Although the use of constants is simple and matches the real error behavior of magnetometers, those skilled in the art can appreciate that, with an increased computation load, more accurate, higher-order models could be used.

The measurement equations of the second attitude and angular rate filter 90 use the transformation equations of the magnetic field vector and acceleration vector from the local navigation tangent frame of reference to the body coordinate frame of reference, which can be modeled as follows:

$$\begin{matrix}{Z}_{mag} = [ \begin{matrix}{mag}_{x}^{B} \\ {mag}_{y}^{B} \\ {mag}_{z}^{B}\end{matrix} ] = {C}_{T}^{B} * [ \begin{matrix}{mag}_{N}^{T} \\ {mag}_{E}^{T} \\ {mag}_{D}^{T}\end{matrix} ] + [ \begin{matrix}{mag}_{X \_ error} \\ {mag}_{y \_ error} \\ {mag}_{z \_ error}\end{matrix} ] & ( 18 ) \\ {Z}_{accel} = [ \begin{matrix}{accel}_{x}^{b} \\ {accel}_{x}^{b} \\ {accel}_{x}^{b}\end{matrix} ] = {C}_{T}^{B} * [ \begin{matrix}0 \\ 0 \\ g\end{matrix} ] , & ( 19 )\end{matrix}$$

in which, Z_{mag} and Z_{accel} refer to the vector of the three-axis magnetic field measurement (after it has compensated for any estimated errors including hard and soft irons in the magnetometer error compensation module 85) and to the vector of the three-axis acceleration measurement, respectively; C^{T}_{B} refers to the transpose matrix of C^{B}_{T} (Equation 7); and [mag_{N}^{T}, mag_{E}^{T}, mag_{D}^{T}]^{T} corresponds to the components of the Earth's magnetic field vector measured in the North (N), East (E) and Down (D) directions in a local navigation tangent frame of reference (T).

Preferably, these well-known local magnetic field vectors are from the World Magnetic Model 73 (FIG. 7) or similar global magnetic field model, e.g., the World Magnetic Model that is provided by the United States National Geospatial Intelligence Agency (NGA), the United Kingdom's Defence Geographic Centre (DGC), and the like. The seven magnetic components computed from the NGA/DGC's World Magnetic Model are as follows:

F—Total Intensity of the geomagnetic field

H—Horizontal Intensity of the geomagnetic field

X—North Component of the geomagnetic field

Y—East Component of the geomagnetic field

Z—Vertical Component of the geomagnetic field

I (DIP)—Geomagnetic Inclination

D (DEC)—Geomagnetic Declination (Magnetic Variation).

The World Magnetic Model 73 automatically applies declination angle corrections to magnetic headings to reference the readings to true north, i.e., geographic north, rather than to magnetic north. The Earth's local magnetic field in the local navigation tangent frame of reference (T) is accurately known for any global location via the World Magnetic Model 73. In many applications, the position solution of the carrier is available from a GPS receiver 74 (FIG. 7). A World Magnetic Model 73 can be employed to provide accurate local magnetic field data in the local navigation tangent frame of reference (T), based on the latitude/longitude/altitude data generated by the GPS receiver 74.

Optionally, a local magnetic field vector(s) can be pre-loaded with approximately “universal” values in the second attitude and angular rate filter 91. This option, which provides a degraded performance, is preferable if GPS position information is not available. The foregoing description is not intended to be exhaustive or to limit the invention to the precise form disclosed. The embodiment was chosen and described to provide the illustration of principles of the invention and its application. Modification and variations are within the scope of invention.

The time propagation module 93 is adapted to perform time propagation of the state vector between filter 90 measurements. The measurement update module 92 is further adapted to perform measurement update of the state vector.

As disclosed hereinbefore, when the location information is not available for the World Magnetic Field model, the measurement vector and measurement equation that are designed for the first attitude and angular filter can also be formed and used for the second attitude and angular rate filter.

Because the system and measurement equations of both the first and second attitude and angular rate filters 80, 90 are nonlinear, the first and second attitude and angular rate filters 80, 90 can be implemented using a nonlinear Kalman filter, such as an extended Kalman filter, a sigma-point Kalman filter, and the like.

Indeed, with both the first and second attitude and angular rate filters 80, 90, the static gravitational acceleration measurements from the three-axis accelerometers are dynamically distorted due to the acceleration of the carrier itself. To mitigate the effect of the carrier's accelerations, the filter adaptive control module 81 (FIG. 8), 92 (FIG. 9) automatically adjusts the gain of the attitude and angular rate filters 80, 90, by monitoring the length of acceleration vector measurements. For example, if the length of acceleration vector measurements is larger than 1 g, the gain of the filters 80 and 90 will be reduced.

Large, time-varying magnetic disturbances could have significant effects on the estimation of the filters. For example, when the carrier passes near to a large magnetic source, which causes a large distortion of the Earth's magnetic field, the magnetometers will measure this large distortion. Once the carrier has ventured beyond the magnetic field strength of the magnetic disturbance source, the Earth's magnetic field can be measured correctly. The filters are designed to respond very quickly to situations where the measurement information is not trusted.

To mitigate the deleterious effect of momentary disturbance of the magnetic field, a filter gain adaptive control 81 (FIG. 8) is provided to achieve highly-accurate state estimation. The filter gain adaptive control module 81 automatically adjusts the gain 87 of the filter 80 with respect to the pseudo-heading measurement data 88 by monitoring the scalar length of the magnetic field vector measurement. For example, if a change in the scalar length of the magnetic field vector measurement is detected, the filter adaptive control module 81 will adjust, i.e., reduce, the gain 87 of filter with respect to the pseudo-heading measurements 88.

Here again, measurements using the second attitude and angular rate filters 90 are formed by the Earth's magnetic field measurements and, as a result, are subject to magnetic field disturbance. To mitigate the effect of magnetic field disturbance, filter gain adaptive control 92 is designed to achieve highly accurate state estimation.

The filter adaptive control module 92 automatically adjusts the gain 97 of the filter 90 with respect to the magnetic field measurements by monitoring the scalar length of magnetic field vector measurements. For example, if a change of the scalar length of magnetic field vector measurement is detected, the gain 97 of the filter 90 with respect to the magnetic field measurements will be reduced.

As a preferred embodiment, the length (magnitude) of the Earth magnetic field vector measured by the three-axis magnetometer and the length (magnitude) of the total acceleration vector measured by the three-axis accelerometer are filtered by a band-pass digital filter, so that both noise and DC offset (DC offset is the mean amplitude of a signal) can be removed for getting a reliable indicator of magnetic field disturbance and change of acceleration for the filter adaptive control modules 81 and 92. The band-pass digital filter has a low cut-off frequency and high cut-off frequency, so that only the signal with frequency between the low cut-off frequency and high frequency is passed through the band-pass frequency.

### Exemplary Uses of the Technology

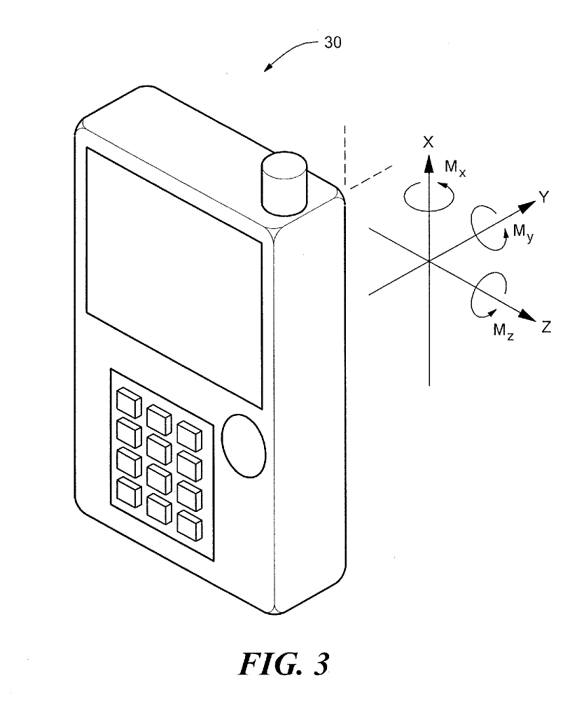

An application of an electronic compass in a cellular telephone 30 is shown in FIG. 3. For the purpose of this disclosure, the cellular telephone 30 is further adapted to execute a three-dimensional (3D) map program and to allow users to rotate the cellular telephone (and therefore the virtual map) about all three axes. Conventional cellular telephones with or without motion sensing would require at least six input devices, e.g., buttons, to accomplish the input signal generation: two buttons for X-axis rotation, two buttons for Y-axis rotation, and two buttons for Z-axis rotation.

With an electronic compass as a motion sensing device, however, direction-arrow buttons are not needed. More specifically, with a electronic compass, as the cellular telephone 30 is rotated, the sensor signals can be processed to provide attitude angles (Φ, θ, and Ψ) and angular rates (ωₓ, ω_{y}, ω_{z}). The attitude angles and angular rates can be input into the translator 29, which translates the attitude angles and angular rates into appropriate input signals 27 to the application program 21.

In short, input signal 27 generation does not require direction-arrow buttons; but, rather, one simply changes the attitude of the cellular telephone 30 to produce sensor signals, e.g., Mₓ, M_{y}, M_{z}, Aₓ, A_{y}, and A_{z}. When the application program is a 3D map application, map rotation about three axes is possible. Advantageously, the panel surface area that would be needed for the conventional navigation buttons is not needed. Consequently, the surface area that otherwise would have been used for navigation buttons can be used for another purpose and/or the cellular telephone 30 can be made smaller.

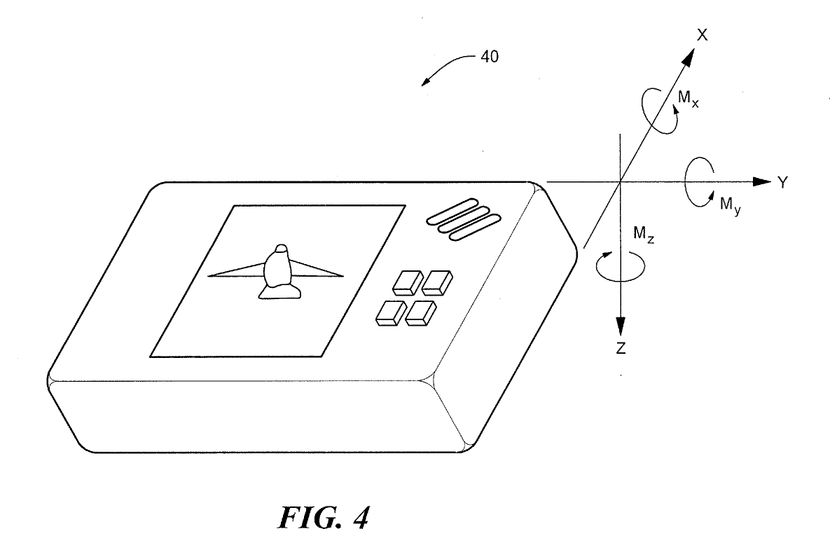

An application for a flight simulator game executable on a portable game machine 40 is shown in FIG. 4. Although for the purposes of this embodiment, the game machine 40 will be a flight simulator, those of ordinary skill in the art can appreciate the applicability of the teachings of the present invention to a myriad of game machines 40 and gaming programs that involve three dimensions and attitude control.

A conventional game machine for controlling the attitude of an airplane requires numerous input devices, e.g., buttons, on the surface of the game device or, alternatively, a joystick that is operatively coupled to the gaming device. In contrast, according to the present invention, with an electronic compass, rotating the gaming machine itself along one or more of its X-, Y-, and/or Z-axis generates airplane attitude input signals that can be used to control the airplane's attitude.

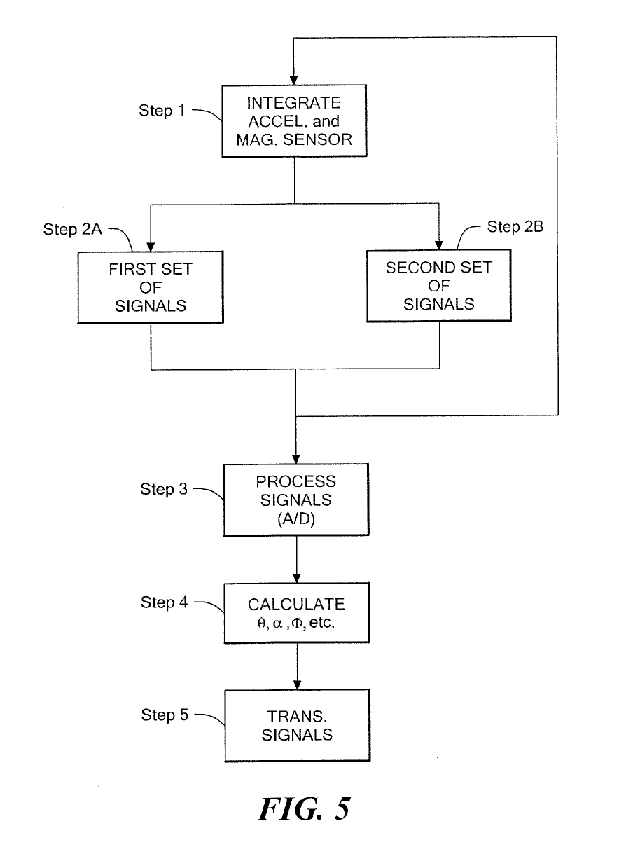

Having described systems for motion- and attitude sensing and portable electronic devices having such systems, methods for providing attitude and change in attitude input signals to an application program; for determining the inertial attitude and change in inertial attitude of an object and for changing an operation performed on an application program executed by the object; and for generating input signals to an application program that is executable on a portable electronic device will now be described. Referring to the flow chart in FIG. 5 and FIG. 2, the methods include integrating a two- or three-axis accelerometer and a three-axis magnetic field sensor into the portable electronic device (STEP 1) and, further, adapting the two- or three-axis accelerometer to produce a first set of signals (STEP 2A) and adapting the three-axis magnetic field sensor, e.g., a electronic compass, to produce a second set of signals (STEP 2B).

The first set of signals produced by the two- or three-axis accelerometer (STEP 2A) correspond to accelerations and/or changes in acceleration in the X-, Y-, and Z-directions, Aₓ, A_{y}, A_{z}, which are proportional to changes in the inertial attitude of the portable electronic device. Similarly, the second set of signals produced by the three-axis magnetic field sensor (STEP 2B) correspond to the magnetic field strength and/or changes in the magnetic field strength about the X-, Y-, and Z-axes, Mₓ, M_{y}, M_{z}, which also are proportional to changes in the inertial attitude of the portable electronic device.

The first and second sets of signals are then processed (STEP 3), which can include, without limitation, converting analog signals to digital signals using an A/D converter. The digital signals can then be processed, e.g., through a processing unit, to calculate one or more of pitch, yaw, roll, which is to say, the attitude of the device and/or changes thereto, and the angular rate about the X-, Y-, and/or Z-axis (STEP 4) and/or changes thereto.

The calculated pitch, yaw, roll, and/or angular rotations are then translated into input signals that are compatible with an application program being executed on or executable by the portable electronic device (STEP 5). More particularly, the calculated pitch, yaw, roll, and/or angular rotations are translated into input signals that change an operation on the application program.

For example, in use in conjunction with 3D image manipulation, the accelerations and magnetic field strengths can first be calculated and then be adapted to describe the 3D image's movement and displacement along and or rotation about the X-, Y- and/or Z-axis. Thus, when the portable electronic device is rotated about one or more of its inertial axes, some or all of the accelerations and magnetic field strengths will be changes, which translates into changes in pitch, yaw, roll, and/or in angular rotation. When these changes are translated and input into the application program being executed on the portable electronic device, the 3D image is moved proportional to the input signals from the rotated portable electronic device.

Application of the present invention, however, is not limited to portable devices. Indeed, the present invention is applicable to any electronic device, whether portable or not, having a human-machine, i.e., user, interface. For example, those of ordinary skill in the art can adapt the pitch, yaw, and roll functions of the present invention for use with a mouse to generate input signals to a personal computer; a remote controller to generate signals to a host device, such as, without limitation, a television, a radio, a DVD player, a stereo system or other multi-media device and an electronic instrument, e.g., an electronic piano or organ.

What we claim is:

1. A method for determining motion information including attitude and angular rate of a dynamic object, the attitude including dynamic roll, dynamic pitch, and dynamic yaw measurements of the dynamic object, the method comprising:
providing a sensing device having a three-axis acceleration sensor and a three-axis magnetic field sensor;
measuring in a body coordinate frame of reference at least one of an intensity and a direction of a magnetic field in three orthogonal or substantially orthogonal directions using the magnetic field sensor;
measuring a total acceleration of the object in the body coordinate frame of reference using the acceleration sensor; and
combining in a filter the at least one of an intensity and a direction of a magnetic field in three orthogonal or substantially orthogonal directions and the total acceleration with a kinematic model of attitude and angular rate of the object, to calculate attitude and angular rate.

2. The method as recited in claim 1, wherein the filter is a first attitude and angular rate filter having a gain and having a state equation including an attitude quaternion differential equation and an angular rate kinematics differential equation.

3. The method as recited in claim 2, wherein the angular rate kinematics differential equation of the object is modeled as a first-order Markov process.

4. The method as recited in claim 2, wherein the first attitude and angular rate filter uses pseudo-roll, pseudo-pitch, and pseudo-heading as a measurement vector and a relationship of a attitude quaternion and roll/pitch/yaw as a measurement equation,
wherein the pseudo-roll and pseudo-pitch are computed using total acceleration and the pseudo-heading is computed using magnetic field measurements that are transformed from the body coordinate frame of reference to a local level frame of reference.

5. The method as recited in claim 4 further comprising performing measurement update of the state vector when a measurement vector is available.

6. The method as recited in claim 5 further comprising performing time propagation of the state vector between filter measurements.

7. The method as recited in claim 4 further comprising adjusting the gain of the first attitude and angular rate filter to reduce measurement update when the object experiences an acceleration disturbance or a magnetic field disturbance.

8. The method as recited in claim 1, wherein the filter is a second attitude and angular rate filter having a gain and having a state equation including an attitude quaternion differential equation, an angular rate kinematics differential equation of the object, and an error model equation for the magnetic field sensor.

9. The method as recited in claim 8, wherein errors of the magnetic field sensor are modeled as constant values.

10. The method as recited in claim 8, wherein the second attitude and angular rate filter uses the magnetic field measurements from the three-axis magnetic field sensor and acceleration measurements from the three-axis acceleration sensor as the filter's measurement vector and employs transformation equations of the magnetic field vector and acceleration vector from the local navigation tangent frame of reference to the body coordinate frame of reference as the filter's measurement model equation, wherein the magnetic field vector in the local navigation tangent frame of reference is known.

11. The method as recited in claim 10 further comprising performing measurement update of a state vector when a measurement vector is available.

12. The method as recited in claim 11 further comprising performing time propagation of the state vector between filter measurements.

13. The method as recited in claim 10 further comprising adjusting the gain of the second attitude and angular rate filter to reduce measurement update when the object experiences an acceleration disturbance or magnetic field disturbance.

14. The method as recited in claim 1 further comprising using a Global Positioning System (GPS) receiver to determine a position of the object, the position including a longitude, a latitude, and an altitude.

15. The method as recited in claim 14 further comprising providing a local magnetic field vector expressed in the local navigation tangent frame of reference using the longitude, the latitude, and the altitude in combination with a World Magnetic Model.

16. The method as recited in claim 1, further including a step to automatically calibrate the three-axis magnetic field sensor by estimating error source including hard/soft iron distortion items of environment, wherein the estimation is based on the principle that a length of an error-free local magnetic field vector is a constant.

17. The method as recited in claim 1, further including a step to automatically calibrate the three-axis acceleration sensor by estimating error sources of the three-axis acceleration, wherein the estimation is based on the principle that an error-free acceleration measurement, when the object is static, is gravitational acceleration only.

18. A system for determining motion information including attitude and angular rate of a dynamic object comprising:
a magnetic field sensor that is adapted to measure in a body coordinate frame of reference at least one of an intensity and a direction of a magnetic field in three orthogonal or substantially orthogonal directions;
an acceleration sensor that is adapted to measure total acceleration of the object in the body coordinate frame of reference; and
a processor that is adapted to calculate attitude and angular rate by combining in a filter total acceleration measurement data and magnetic field measurement data with a kinematic model of attitude and angular rate of the object.

19. The system as recited in claim 18, wherein the filter is a first attitude and angular rate filter having a gain and having a system state equation including an attitude quaternion differential equation and an angular rate kinematics differential equation of the object.

20. The system as recited in claim 19, wherein the angular rate kinematics differential equation of the object is modeled as a first-order Markov process.

21. The system as recited in claim 19, wherein the first attitude and angular rate filter uses pseudo-roll, pseudo-pitch, and pseudo-heading angles as the filter's measurement vector and a relationship between the attitude quaternion and roll, pitch, and yaw angles as the filter's measurement equation, wherein the pseudo-roll and pseudo-pitch are computed using total acceleration and the pseudo-heading is computed using magnetic field measurements that are transformed from the coordinate body frame of reference to a local level frame of reference.

22. The system as recited in claim 19, wherein the filter performs measurement update of a state vector when the measurement vector is available.

23. The system as recited in claim 22, wherein the filter performs time propagation of the state vector between filter measurements.

24. The system as recited in claim 18, wherein the processor is structured and arranged to automatically calibrate the three-axis magnetic field sensor by estimating an error source that includes hard/soft iron distortions of the magnetic filed from the surrounding environment of the three-axis magnetic filed sensor, wherein the error source estimation is based on the principle that a length of an error-free local magnetic field vector is a constant.

25. The system as recited in claim 22, wherein the filter further adjusts the gain of the first attitude and angular rate filter to reduce the measurement update when the object experiences an acceleration or magnetic field disturbance.

26. The system as recited in claim 18, wherein the filter is a second attitude and angular rate filter having a gain and having a state equation including an attitude quaternion differential equation, an angular rate kinematics differential equation of the object, and an error model equation of the three-axis magnetic field sensor.

27. The system as recited in claim 26, wherein the second attitude and angular rate filter uses the magnetic field measurements from the three-axis magnetic field sensor and acceleration measurements from the three-axis acceleration sensor as the filter's measurement vector and employs the transformation equations of a magnetic field vector and an acceleration vector from the local navigation tangent frame of reference to the body coordinate frame of reference as the filter's measurement model equation,
wherein the magnetic field vector in the local navigation tangent frame of reference is known.

28. The system as recited in claim 18 further comprising a Global Positioning System (GPS) receiver that is adapted to determine a position of the object, the position including a longitude, a latitude, and an altitude.

29. The system as recited in claim 28 further comprising means for providing the magnetic field vector in the local navigation tangent frame of reference using the longitude, the latitude, and the altitude in combination with a World Magnetic Model.
